(19) United States
(12) Patent Application Publication
(10) Pub. No.: US 2025/0013044 A1
(43) Pub. Date: Jan. 9, 2025

(54) Head-Wearable Display Device

(71) Applicant: Lusospace, Projectos Engenharia Lda, Lisboa (PT)

(72) Inventors: Ivo Yves DE MATOS PEREIRA VIEIRA, Lisboa (PT); Joao Rendeiro MARQUES MENDES LOPES, Lisboa (PT); Joao Carlos DE SOUSA GOUVEIA PEREIRA RICARTE, Lisboa (PT)

(21) Appl. No.: 18/708,241

(22) PCT Filed: Nov. 7, 2022
(86) PCT No.: PCT/EP2022/080960

§ 371 Date: May 8, 2024

(30) Foreign Application Priority Data
Nov. 12, 2021 (DE) 10 2021 129 587.4

(51) Int. Cl. G02B 27/01

(52) U.S. Cl. CPC G02B 27/0103; G02B 2027/0123; G02B 2027/0178

(57) ABSTRACT

A head-wearable display device is provided, which includes: a see-through member providing a transparent see-through area; a plurality of more than two display segments to emit sub-image portions of a display image, the plurality of display segments disposed on the see-through member in a manner distributed across a display area of the see-through member, each of the plurality of display segments comprising a plurality of pixel elements, wherein an intra-segment pixel distance is smaller than an inter-segment pixel distance; and a collimating optical system disposed on the see-through member to direct the sub-image portions towards an exit pupil of the display device, wherein the collimating optical system includes, in relation to each of the plurality of display segments, a respective plurality of collimating optical elements each configured to direct the sub-image portion emitted by the associated display segment towards the exit pupil with substantially the same direction.

### CROSS-REFERENCE TO RELATED APPLICATIONS

This patent application is a national stage entry under 35 U.S.C. § 371 of PCT International Patent Application No. PCT/EP2022/080960, filed on Nov. 7, 2022, which claims the benefit of and priority to German Patent Application No. 102021129587.4, filed on Nov. 12, 2021. Each of these patent applications is herein incorporated by reference in its entirety.

### FIELD OF THE DISCLOSURE

The present disclosure relates to improvements in head-wearable display devices. In particular, the present disclosure relates to improvements in head-wearable display devices for augmented reality (AR) applications.

### BACKGROUND

Great efforts are currently being made in research and industry to develop head-wearable display devices. For the state of the art regarding head-wearable display devices, reference can be made, for example, to U.S. Pat. No. 9,964,767 B2. Such head-wearable display devices are sometimes also referred to as head-mounted display devices, abbreviated HMD. In head-wearable display devices for AR applications, the display device regularly comprises at least one see-through element, which is arranged in front of (at least) one eye of the wearer (user) when the display device is in a proper, intended wearing position. Through the see-through element, the user can perceive a real image of the physical environment. By superimposing an artificially generated image into the field of view of the eye, the user can perceive the artificial image in superposition with the real image of the environment. The artificial image may, for example, provide the user with information that may be helpful in performing an activity. The superimposed artificial image can, for example, comprise textual components or/and graphical components.

### SUMMARY

There is often a desire to make the exit pupil of a head-wearable display device as large as possible so that, for example, despite any positioning inaccuracies when the display device is put on, the user can still capture the complete artificial image. Also, it cannot be guaranteed that the user always looks precisely in the same direction to be able to see the artificial image. A sufficiently large exit pupil can ensure that the user still sees the artificial image completely even if he (slightly) changes his viewing direction.

For a large exit pupil (sometimes also referred to as an eye box), the optical elements of a collimating optical system arranged on the see-through element, by means of which the artificial image generated by light-generating elements (pixel elements) of the display device is collimated and directed to the eye, can be made correspondingly large. If the pixel elements are also arranged on the transparent element, the then regularly very small distance between the pixel elements and the optical elements of the collimating optical system can lead to comparatively strong aberrations of the artificial image hitting the eye due to the small f-number. Such aberrations interfere with the visual perception and, under certain circumstances, may even impair the perception of the meaning of superimposed information.

It is therefore an object of at least certain embodiments of the present disclosure to provide a head-wearable display device which provides a comparatively large exit pupil, yet is capable of superimposing an artificial image into the field of view of a user of the head-wearable display device with comparatively little aberration.

For achieving this object, according to a first aspect, the present disclosure provides a head-wearable display device comprising: a see-through member providing a transparent see-through area; a plurality of more than two display segments to emit sub-image portions of a display image, the plurality of display segments disposed on the see-through member in a manner distributed across a display area of the see-through member, each of the plurality of display segments comprising a plurality of pixel elements, wherein an intra-segment pixel distance is smaller than an inter-segment pixel distance; and a collimating optical system disposed on the see-through member to direct the sub-image portions towards an exit pupil of the display device, wherein the collimating optical system includes, in relation to each of the plurality of display segments, a respective plurality of collimating optical elements each configured to direct the sub-image portion emitted by the associated display segment towards the exit pupil with substantially the same direction.

The collimating optical system serves to collimate, i.e. at least to parallelize as far as possible, the beams emitted by the pixel elements. Each of the display segments has its own plurality of collimating optical elements associated with it. Each of the optical elements associated with a respective one of the display segments creates an optical image of the sub-image portion produced by the pixel elements of the respective display segment, the associated optical elements of the respective display segment all directing the imaged sub-image portion in substantially the same direction towards the exit pupil.

With essentially the same direction the following is meant: A particular pixel element of the respective display segment is considered. From this pixel element under consideration, a divergent beam is incident on each of the optical elements associated with the display segment in question. These emit a collimated, divergence-reduced beam in the direction of the exit pupil. In this case, the collimated beams of the pixel element under consideration all run essentially parallel to each other, i.e. they are oriented in essentially the same direction. Let now another pixel element of the relevant display segment be considered. Also from this other pixel element, a divergent beam is incident on each of the optical elements associated with the display segment. Once again, collimated beams are output from the optical elements in the direction of the exit pupil, these collimating beams again being substantially parallel to each other. The same applies to the beams of all pixel elements of the display segment under consideration. Since the beams from the various pixel elements together make up the sub-image portion in question, it can be said that the imaged sub-image portions from the optical elements (associated with the display segment in question) are directed toward the exit pupil in essentially the same direction. However, this does not mean that the collimated beams of different pixel elements of the display segment in question must also be parallel to each other. Since the beams of different pixel elements are each incident on a respective one of the optical elements at a different angle, the collimated beams of these pixel elements output from the respective optical element will also be at an angle rather than parallel to each other. To this extent, each imaged sub-image portion output by an optical element in the direction of the exit pupil is composed of a plurality of collimated beams. Although these run at different angles in relation to each other, they are oriented essentially the same from optical element to optical element for all optical elements associated with the display segment under consideration. This results in the statement that the imaged sub-image portions of the optical elements associated with a display segment are all projected onto the exit pupil in essentially the same direction.

By associating a plurality of collimating optical elements with each display segment, the individual optical elements can be kept comparatively small in their extension parallel to the display area for a given size of the exit pupil, and in particular considerably smaller than in conventional designs with only one collimating optical element per display segment. Conversely, by providing a correspondingly large number of collimating optical elements per display segment, a comparatively large exit pupil of the display device can be realized, whereby the individual collimating optical elements can still have a smaller size than in conventional display devices with a one-to-one relationship between display segments and collimating optical elements. A reduced size of the collimating optical elements is accompanied by an increased f-number and, as a result, lower aberrations. For example, the number of collimating optical elements per display segment can be 2×2, 3×3, 4×4, or 5×5. It is understood that these are only examples without limiting effect for the present disclosure.

The association of a collimating optical element with a display segment manifests itself in such a positioning or/and orientation or/and design of the optical element concerned that a sub-image portion emitted by the display element is directed by the optical element in the direction towards the exit pupil. On the other hand, in the absence of an association, the sub-image portion is directed in a direction away from the exit pupil; the corresponding light rays then do not reach the eye of the user.

The collimating optical elements of the collimating optical system are arranged in a distributed manner along the display area, and they may all be arranged in a common plane or may be divided into different planes. Adjacent collimating optical elements of the collimating optical system (i.e., adjacent when viewed along the surface of the see-through element) may be spaced apart, adjacent, or even merge, particularly when the collimating optical elements are realized by holographic optical elements. In certain embodiments, it is provided that such adjacent collimating optical elements are associated with different display segments. In this way, an interleaved arrangement image of the collimating optical elements assigned to different display segments can be realized.

In the head-wearable display devices contemplated by the present disclosure, light-generating elements (the pixel elements), by means of which the artificial image is generated, are arranged on the see-through element. In this regard, the present disclosure assumes a segmented distribution of the pixel elements, i.e., the pixel elements are not all distributed in a regular matrix arrangement with a pixel spacing that is constant over the entire display area, but they are arranged in a locally clustered manner (as shown and described, for example, in PCT International Application Publication No. WO 2014/063716 A1, see in particular FIG. 3a therein; the contents of this WO document are hereby incorporated in their entirety by express reference). Each local cluster forms a so-called display segment. The display segments can also be referred to as pixel patches. Within each display segment, the mutual distance between adjacent pixel elements (intrasegment pixel pitch) is smaller than the distance between pixel elements belonging to adjacent display segments (intersegment pixel distance). It can be said that the segment distance between adjacent display segments is larger than the pixel distance between adjacent pixel elements within a display segment. For example, the segment spacing is at least three times or at least five times or at least ten times or at least 20 times as large as the (largest) pixel spacing within a display segment.

Within a display segment, the pixel elements of the display segment can, for example, be arranged at grid points of an (imaginary) regular two-dimensional x,y grid, where the pixel spacing in the x-direction of the grid can be the same as or different from the pixel spacing in the y-direction of the grid.

The number of pixel elements per display segment may be the same or different. At least a partial number of the display segments may, for example, be formed by a 2×2 or 3×3 or 4×4 or 5×5 arrangement of pixel elements. Again, these numerical indications are, of course, only exemplary and not to be understood as limiting in any way. The total number of pixel elements of a display segment may, for example, be in the single-digit or two-digit range.

Each pixel element serves to generate a pixel (image point) of a display image generated by the display device. In the case of a monochromatic embodiment of the display device, each pixel element allows the generation of a monochromatic pixel of the display image. In the case where the display device allows the generation of polychromatic display images, each pixel element may generate a polychromatic pixel of the display image. For example, for this purpose, each pixel element may comprise a plurality of sub-pixel elements that together generate the respective polychromatic pixel and each emit a different primary color (for example, red, green and blue).

The see-through element may extend over both eyes of the user, as in the case of a visor of a helmet, for example. In this case, a respective plurality of display segments can be formed on the see-through element in association with each of the two eyes. Likewise, it is conceivable that in such a visor-like design of the see-through element, a plurality of display segments is formed only on one half of the visor (right half or left half), so that an art image can be superimposed only in the field of view of one of the eyes. Alternatively, a design of the head-wearable display device in the manner of a pair of spectacles with two separate eyeglass lenses is also conceivable. Here, each spectacle lens can be designed as a display lens with a respective plurality of display segments or only one of the spectacle lenses can be designed with a plurality of display segments. Again alternatively, it is conceivable that the head-wearable display device may comprise only a single see-through element that sits in front of only one of the user's eyes when the display device is in the wearing position; the other eye of the user may then have a clear view of the surrounding real image. For example, in display devices having such a single-eye display glass, the single display glass may be configured to be foldable so that it can be folded up out of the field of view of the eye in question when not needed and folded down into the field of view when needed.

According to another, second aspect, the present disclosure provides a head-wearable display device comprising: a see-through member providing a transparent see-through area; a plurality of more than two display segments to emit sub-image portions of a display image, the plurality of display segments disposed on the see-through member in a manner distributed across a display area of the see-through member, each of the plurality of display segments comprising a plurality of pixel elements, wherein an intra-segment pixel distance is smaller than an inter-segment pixel distance; a collimating optical system disposed on the see-through member to direct the sub-image portions towards an exit pupil of the display device, wherein the collimating optical system includes, in relation to each of the plurality of display segments, at least one collimating optical element configured to direct the sub-image portion emitted by the associated display segment towards the exit pupil; a controllable beam steering material disposed on the see-through element between the display segments and the collimating optical elements in at least one beam steering layer in the propagation path of the sub-image portions; and control circuitry for controlling the beam steering material between different steering states.

In certain embodiments, the beam steering material comprises a liquid crystal material. The present disclosure is not limited thereto, of course; other conceivable beam steering materials include, for example, electro-optic crystal materials.

In the second aspect, the beam steering material is disposed on the see-through element spatially between the display segments and the collimating optical elements. This allows for a compact design. Provided that the collimating optical elements act as reflectors, the beam steering material is then traversed twice by the beams of the pixel elements, the first time on the way from the pixel elements to the collimating optical elements and the second time on the way from the collimating optical elements to the exit pupil of the display device. Provided that the collimating optical elements act transmissively, the beam steering material is traversed only once by the beams of the pixel elements, namely on the way from the pixel elements to the collimating optical elements.

There may be provided a single layer of the beam steering material or there may be provided several such layers, also directly adjacent to each other. In the case of a multilayer arrangement of the beam steering material, at least two layers may be different in material, particularly such layers which are arranged adjacent to each other. Each layer of the beam steering material may extend continuously over substantially the entire extent of the display area.

The controllability of the beam steering material may be, for example, an electrical controllability. For example, by changing an electrical potential applied to the beam steering material, its steering behavior can be influenced.

The provision of the beam steering material allows for further improvements or enhancements to the functionality of the head-wearable display device. Thus, according to certain embodiments, an enlargement of the exit pupil of the display device is achievable in that the control circuitry is configured to control a first display segment to emit a sub-image portion at a first point in time, control a second display segment to emit the same sub-image portion at a second point in time and control the beam steering material to assume a different steering state at the second point in time than at the first point in time, such that the sub-image portion emitted by the second display segment at the second time point leaves the display device substantially in the same direction as the sub-image portion emitted by the first display segment at the first time point.

These embodiments are based on the following consideration: Consider two display segments, for example two adjacent display segments. Without the controllable beam steering material, a sub-image portion emitted from a first of the two display segments will be directed in a first direction toward the exit pupil by a collimating optical element associated with the first display segment, and a sub-image portion emitted by the second of the display segments will be directed by a collimating optical element associated with the second display segment in a different, second direction toward the exit pupil. If the beam steering material is now provided, it can be achieved through control of the beam steering material that the sub-image portion emitted by the second display segment, when passing through the beam steering material, undergoes such a deflection that it leaves the display device essentially in the first direction. This effect of the beam steering material can be used to emit the same sub-image portion with a time delay from two different display segments and to ensure, by appropriate control of the beam steering material, that the two sub-image portions, which are identical in content, leave the display device substantially in the same direction. In this way, the effective exit pupil of the display device can be increased. The time interval between the two emissions of the sub-image portion (once from the first display segment, the other time from the second display segment) is, e.g., no more than half a second or no more than 300 milliseconds or no more than 100 milliseconds and, in certain embodiments, is in the two-digit or even single-digit millisecond range.

At a time t0, for example, the first display segment can emit a first sub-image portion and the second display segment can emit a second sub-image portion with different image content than the first sub-image portion. At time t0, the beam steering material assumes a first steering state. At a subsequent time t1 the first sub-image portion is emitted again, but this time by the second display segment, with the beam steering material being set to a different, second steering state. Switching the steering state of the beam steering material between times t0 and t1 causes the first sub-image portion to leave the display device in essentially the same direction at both times. In contrast, without changing the steering state of the beam steering material, the first sub-image portion would leave the display device at time t1 in a different direction than at time to. Due to the small time interval between the times t0 and t1, the user does not perceive the time-delayed emission of the first sub-image portion, or at least does not perceive it in a disturbing manner.

The steering effect of the beam steering material can be used not only to increase the exit pupil (in that, as explained, sub-image portions of the same content emitted by different, in particular adjacent, display segments leave the display device in essentially the same direction, i.e. with essentially parallel collimated beams of corresponding pixels of the two sub-image portions). It may alternatively or additionally be used to generate an artificial image with increased resolution, i.e. increased with respect to the physical resolution of the display device given by the number of pixel elements. In this regard, certain embodiments provide that the control circuit is configured to control a display segment to emit a first sub-image portion at a first point in time, control the display segment to emit a second sub-image portion at a second point in time, and control the beam steering material to assume a different steering state at the second point in time than at the first point in time, such that the two sub-image portions emitted by the display segment at the first and second points in time leave the display device with interleaved pixel rasters. For example, the time interval between the emission of the two sub-image portions is not more than 300 ms, or not more than 200 ms, or not more than 100 ms, or not more than 75 ms, or not more than 50 ms, or not more than 30 ms, or not more than 20 ms.

By interlaced pixel rasters is meant that the pixel raster of the sub-image portion emitted by the display segment at the first point in time and the pixel raster of the sub-image portion emitted by the display segment at the second point in time are slightly offset from each other when leaving the display device. Thus, the pixels of the two sub-image portions are not congruent. The offset is less than the intrasegment pixel pitch and is, for example, about half the intrasegment pixel pitch. Due to the offset of the pixel rasters, the impression of an increased resolution of the display device can be achieved for the viewer if the two sub-image portions are emitted in sufficiently rapid succession.

Still another, third aspect of the present disclosure relates to a head-wearable display device comprising: a see-through member providing a transparent see-through area; a plurality of more than two display segments to emit sub-image portions of a display image, the plurality of display segments disposed on the see-through member in a manner distributed across a display area of the see-through member, each of the plurality of display segments comprising a plurality of pixel elements, wherein an intra-segment pixel distance is smaller than an inter-segment pixel distance; a collimating optical system disposed on the see-through member to direct the sub-image portions towards an exit pupil of the display device, wherein the collimating optical system includes, in relation to each of the plurality of display segments, at least one collimating optical element configured to direct the sub-image portion emitted by the associated display segment towards the exit pupil; and control circuitry to control the display segments, wherein the control circuitry is configured to control at least one of the display segments to emit a sub-image portion at a selected one of a first intra-segment position and a second intra-segment position based on an expected eye focusing state, the second intra-segment position being shifted relative to the first intra-segment position by at least one pixel element.

Behind this aspect is the recognition that when the user's eye focuses on a distant point (point at infinity), a collimating optical element can direct a sub-image portion emitted from an associated display segment to the user's eye such that the light rays of that sub-image portion enter the pupil of the eye in a “well-positioned” manner, so to speak, and the sub-image portion is sufficiently sharply imaged on the retina. If, on the other hand, the user's eye focuses on a closer point, the light rays of the sub-image portion may no longer enter the eye in a “well-positioned” manner. It may then be that the sub-image portion is no longer imaged onto a point of sharp vision on the retina. This can be remedied if the sub-image portion is shifted by at least one pixel element within the display segment when the eye is in the near-focusing state. Thus, if a particular pixel of the sub-image portion is generated by a particular pixel element of the display segment when the eye is in the far-focus state, it may be useful for the purpose of equally sharp imaging of the sub-image portion on the retina of the eye if, when the eye is in the near-focus state, that particular pixel of the sub-image portion is generated by another pixel element of the display segment. This other pixel element may be, for example, an adjacent pixel element or it may be two or more pixel positions away from the particular pixel element. It can be said that when the eye is near-focused, the sub-image portion is emitted at a different position within the display segment (i.e., intrasegment position) than when the eye is far-focused. The emitting position of the sub-image portion with near focusing of the eye is shifted by at least one pixel position compared to the position with distant focusing.

Whether the eye assumes a far-focusing state or a near-focusing state can be predicted from the image data representing the display images to be displayed, which can be analyzed accordingly by the control circuit. Accordingly, based on the image data, the control circuit can expect a particular focusing state of the eye. Based on the expected focusing state, the control circuit then controls the intrasegment position of the partial image to be emitted from the respective display segment.

Controlling the emitting position of a sub-image portion within a display segment based on the expected focusing state of the eye may be particularly, but not limited to, useful when a sub-image portion is emitted not only from a single display segment, but when the same sub-image portion is emitted in multiple replications from multiple display segments. With respect to such replication techniques, reference is made to PCT International Patent Application No. PCT/EP2020/070145, filed on Jul. 16, 2020, the contents of which are hereby incorporated by express reference in their entirety. In certain embodiments, it may be sufficient for only a partial number of the display segments displaying the various replicas of a sub-image portion to have an adjustment of the intrasegment emitting position as a function of the eye focus state. In other embodiments, such adjustment may be appropriate or required for all of the display segments displaying the various replicas of a sub-image portion.

Yet another, fourth aspect of the present disclosure provides a head-wearable display device comprising: a see-through member providing a transparent see-through area; a plurality of more than two display segments to emit sub-image portions of a display image, the plurality of display segments disposed on the see-through member in a manner distributed across a display area of the see-through member, each of the plurality of display segments comprising a plurality of pixel elements, wherein an intra-segment pixel distance is smaller than an inter-segment pixel distance between neighboring display segments; and a collimating optical system disposed on the see-through member to direct the sub-image portions towards an exit pupil of the display device, wherein the collimating optical system includes, in relation to each of the plurality of display segments, a first optical element and a second optical element disposed successively in the propagation path of the sub-image portion emitted by the associated display segment, each of the first and second optical elements designed to reduce the divergence of a beam carrying the sub-image portion, one of the first and second optical elements effective to reflect the beam and the other of the first and second optical elements effective to transmit the beam.

In certain embodiments, the collimating optical elements of the collimating optical system comprise holographic optical elements. Alternatively or additionally, the collimating optical elements may comprise diffractive optical elements or/and lens elements or/and specular reflectors. In certain embodiments, the collimating optical system comprises collimating reflectors. In other embodiments, the collimating optical system comprises collimating elements having a transmission function.

### BRIEF DESCRIPTION OF THE DRAWINGS

Embodiments of the present disclosure are further explained below with reference to the drawings. These depict:

FIG. 1 in perspective a head-wearable display device according to an exemplary embodiment,

FIG. 2 schematically a section of a display glass of the display device of FIG. 1 with display segments and pixel elements,

FIG. 3 schematically an embodiment of a head-wearable display device with a display segment to which several collimating optical elements are assigned,

FIG. 4 schematically an embodiment of a head-wearable display device with interleaved collimating optical elements,

FIGS. 5a and 5b schematically an exemplary embodiment of a head-wearable display device with an electrically controllable beam steering material in two different steering states of the beam steering material,

FIG. 6 schematically a further embodiment of a head-wearable display device with an electrically controllable beam steering material,

FIG. 7 schematically yet another embodiment of a head-wearable display device with an electrically controllable beam steering material,

FIG. 8 schematically an embodiment of a head-wearable display device with a plurality of divergence-reducing optical elements for each display segment which are arranged one behind the other in the beam path, and

FIGS. 9a, 9b, 9c schematically an exemplary embodiment of a head-wearable display device with a far/near adaptation function.

### DETAILED DESCRIPTION

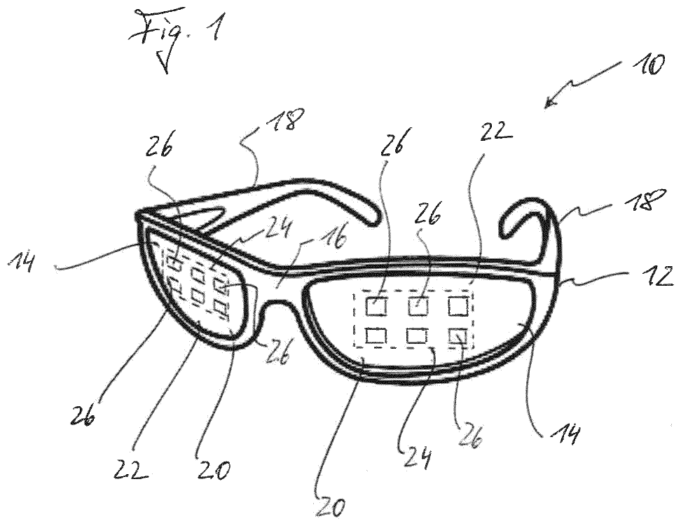

Reference is first made to FIG. 1. The head-wearable display device shown there is generally designated 10. It has a frame 12 which can be mounted on the head of a user of the display device 10 and which serves as a mount for at least one display glass 14. In the example case shown, the display device 10 is configured as a display eyewear, and the frame 12 is accordingly configured as an eyewear frame with two eyewear lenses enclosed therein. At least one of the eyewear lenses is configured as a display glass 14 with a function for superimposing an artificial image; in the example case shown, both eyewear lenses of the display eyewear 10 are configured with such a display function. The frame 12 comprises a nosepiece 16 and two side earpieces 18; by means of the nosepieces 16, 18, the display eyewear 10 can be worn by a user on the nose and cars in the manner of a conventional pair of optical glasses serving as a visual aid. It is understood that other embodiments of the display device 10 are conceivable, for example with a single display glass positionable in front of only one eye of the user, or with a display screen extending over both eyes in the form of a visor.

In the example case shown, the display eyewear 10 is designed to implement an AR (augmented reality) function in which the display glasses 14 allow the user to see through to the surrounding real world and the artificial image generated by the display glasses 14 is superimposed on the real-world image seen by the user.

Each display glass 14 of the display eyewear 10 has a transparent glass body 20 held by the frame (eyewear frame) 12, which forms a see-through element as defined in the present disclosure and provides a transparent see-through area 22 for viewing the real world. When the word “glass” is used herein in connection with the terms display glass or glass body, it is understood that the use of a glass material is not necessarily implied hereby; a transparent plastic material can of course also be used as the material.

The glass body 20 forms an active region 24, which is schematically indicated in FIG. 1 by a dashed rectangle and designates that region of the glass body 20 in which the glass body 20 is equipped with a plurality of display segments 26. Accordingly, the active region 24 may also be referred to as the display region of the display glass 14. The display segments 26 are distributed in the active area 24 in a—in the example case shown-regular arrangement, so that between each pair of adjacent display segments 26 there is an area of the glass body 20 in which the user has a free view of the real world in front of him. In the area of the display segments 26, direct viewing may be limited or obstructed. However, if the area of the part of the viewing area 22 not occupied by the display segments 26 is sufficiently large, this will not be perceived as disturbing by the user.

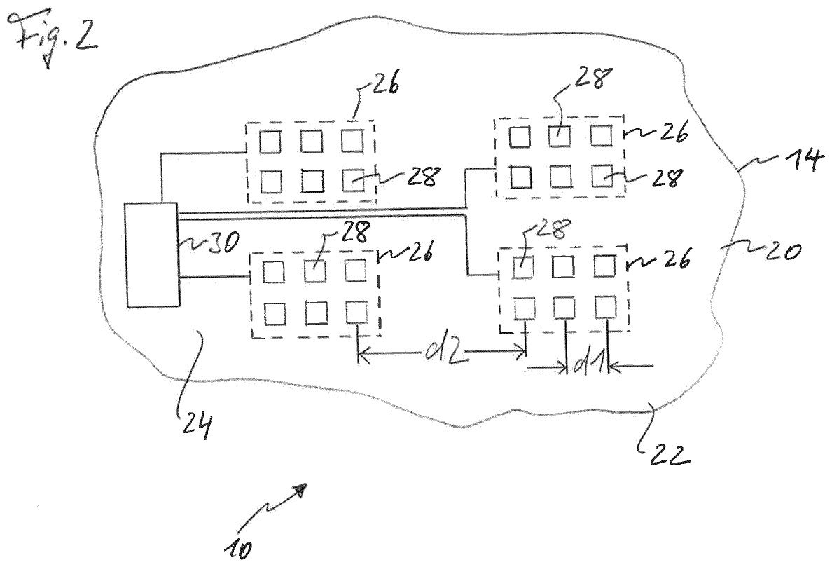

Reference is now made to FIG. 2, which shows a schematic enlarged view of a portion of a display glass 14. As can be seen in FIG. 2, each display segment 26 is composed of a plurality of pixel elements 28 which are distributed within each display segment 26 in a—in the example case shown-regular arrangement over the area of the respective display segment 26.

Each pixel element 28 serves to generate a monochromatic or polychromatic pixel of an artificial image generated by the display device 10. In certain embodiments, the pixel elements 28 are formed by light emitting diodes, such as organic light emitting diodes (OLEDs). They may be mounted on an outer surface of the respective display glass 14 or, in the case of a multilayer embodiment of the display glass 14, they may be incorporated therein.

A pixel pitch d1 shown in FIG. 2 denotes the distance between two pixel elements 28 which are adjacent in a certain direction within a display segment 26; a pixel pitch d2 denotes the distance between two pixel elements 28 which are adjacent in the same direction but belong to adjacent display segments 26. It can already be seen from the schematic representation of FIG. 2 that the pixel pitch d2 is considerably larger, namely several times larger (for example at least three times larger or at least five times larger or at least ten times larger) than the pixel pitch d1. The pixel pitch d1 denotes an intrasegment pixel pitch, while the pixel pitch d2 denotes an intersegment pixel pitch. The specified size relationship between the intrasegment pixel pitch and the intersegment pixel pitch applies in any direction of the extension of the active area 24. Therefore, with reference to FIG. 2, the specified size relationship also applies, for example, in the drawing plane perpendicular to the direction in which the pitches d1, d2 are plotted. However, the intrasegment pixel pitch need not have the same value d1 in all directions of the extension of the active area 24, likewise the intersegment pixel pitch need not have the same value d2 in all directions of the extension of the active area 24.

The explained difference in intrasegment pixel pitch and intrasegment pixel pitch results in an appearance of the entirety of the pixel elements 28 having local clusters, each of these clusters forming one of the display segments 26.

An electronic control circuit 30 combines all hardware and software components to control the pixel elements 28 individually and on a segment-by-segment basis to emit light. The fact that in FIG. 2 the control circuit 30 is shown only as a single block is due to the schematic representation and is not intended to exclude a spatially or/and functionally distributed arrangement of different components of the control circuit 30. At least parts of the control circuit 30 may be arranged directly on the display device 10, for example on the frame 12 or/and on one or both of the display glasses 14. However, it is not excluded within the scope of the present disclosure to accommodate at least parts of the control circuit 30 outside the display device 10 in a separate device (for example together with a battery-supported electrical power supply) and to supply corresponding control information to the display device 10 via a cable connection not shown in more detail or alternatively via a radio link.

Each display glass 14 carries a collimating optical system (not shown in detail in FIGS. 1 and 2, but shown schematically in various configurations in the further figures), which serves to collimate, i.e. at least to the greatest possible extent parallelize, the light beams emitted by the pixel elements 28 and direct collimated light beams onto an exit pupil of the display device 10 and thus onto the relevant eye of a user wearing the display device 10. In the following description, it is understood that the collimating optical system comprises at least one holographic optical element, or HOE, in association with each of the display segments 26. It is understood that holographic optical elements are only one example of optical elements that can be used for collimation purposes, and that optical lenses (including microlens arrays) or diffractive elements, for example, can be used alternatively.

Furthermore, in the following description, it is assumed that the light emission from the pixel elements 28 (meaning the emission of the useful light, i.e., the light carrying the actual pixel information) is in the direction away from the user's eye, namely in a forward direction from the perspective of the user carrying the display device 10. Accordingly, said collimating optical system comprises, in association with each of the display segments 26, at least one reflective collimating HOE which reflects the light beams emitted by the pixel elements 28 back in a direction towards the eye of the viewer with reduced divergence. However, it is understood that the present disclosure is not limited to this and that instead the light emission from the pixel elements 28 may be in the opposite direction, towards the eye. In this case, the collimating optical system may comprise, in association with each of the display segments 26, at least one transmitting collimating HOE which transmits the light beams emitted by the pixel elements 28 with reduced divergence towards the eye. The optical elements of the collimating optical system may also be arranged on an outer surface (front, back) of the respective display glass 14 or embedded in the display glass 14.

The light beams emitted by the pixel elements 28 of a display segment 26 together form a sub-image portion, i.e., a portion of an artificial image generated by the display device 10. The control circuit 30 may control the display segments 26, more specifically their respective pixel elements 28, such that each display segment 26 emits a different sub-image portion of the artificial augmented reality image. Alternatively or additionally, it is possible for the control circuitry 30 to control the display segments 26 such that multiple display segments each emit the same sub-image portion of the said artificial image. In the latter case, the same image content is emitted multiple times, namely by different display segments 26. Content-different sub-image portions of the overall image can thus each be emitted multiple times, namely by a different group of display segments 26 in each case. Such replication of image content may be useful to implement an enlarged exit pupil of the display device 10.

With reference to the further figures, various concepts for the structural or/and functional design of the display device 10 are explained below. It should be emphasized that these figures are highly schematic and their form of presentation has been chosen with a particular view to explaining the concepts in question in an understandable manner. In the further figures, identical or identically operating elements are each provided with the same reference signs as in FIGS. 1 and 2, but supplemented by a lower-case letter. Unless otherwise stated below, reference is made to the above explanations for such identical or identically operating elements.

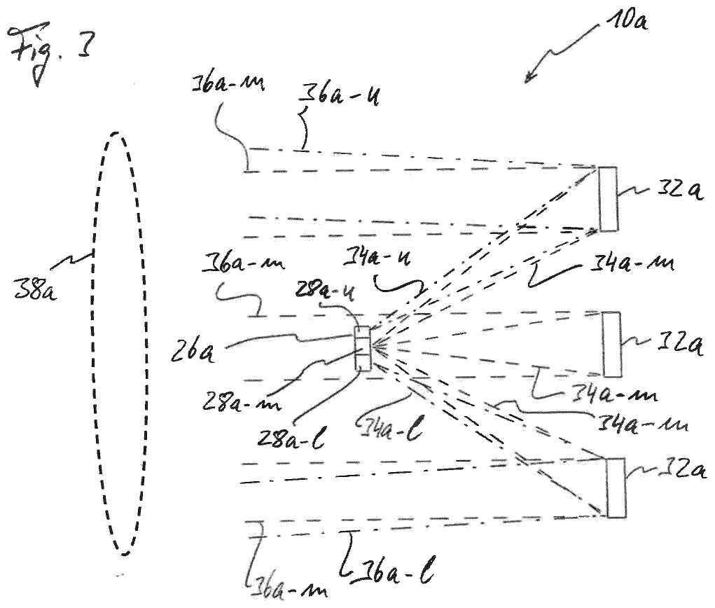

Reference is next made to the embodiment of FIG. 3. In this figure, three adjacent pixel elements 28a belonging to the same display segment 26a are shown. The three pixel elements 28a shown are purely representative; in a real embodiment, the display segment 26a may include any other plurality of pixel elements 28a. For better distinction, the three pixel elements 28a shown are further individualized by an appended letter. The display segment 26a shown in FIG. 3 is representative of each of the display segments 26 of a head-wearable display device 10a, such as the display eyewear 10 of FIG. 1. The concept explained below may be implemented for each of the display segments 26 of the display device 10a.

Associated with the display segment 26a of FIG. 3 are a plurality of reflective HOEs 32a having a collimating function for the light beams emitted by the pixel elements 28a of the display segment 26a. The HOEs 32a are distributed in a plane which follows the extension of the active area 24, and they are spaced apart from each other in the example case shown. Again, the three HOEs 32a shown are to be understood as representative only; any other plurality of HOEs 32a may be associated with the display segment 26a. The association of the HOEs 32a with the display segment 26a is manifested by the fact that each of the HOEs 32a is adapted to direct a sub-image portion emitted from the display segment 26a to the exit pupil of the display device 10a. In contrast, the HOEs 32a have no such directing function for light beams emitted from other display segments 26a of the display device 10a. Such light emitted by other display segments 26a of the display device 10a and incident on the HOEs 32a may also be reflected at least in part by the HOEs 32a, but it is not directed to the exit pupil of the display device 10a in the form of collimated light beams and is therefore not available for user perception of the artificial AR image. The other display segments 26a of the display device 10a may each have their own set of associated HOEs 32a.

In FIG. 3, a plurality of light beams 34a are illustrated, each emanating from one of the three pixel elements 28a shown and incident on one of the three HOEs 32a shown. The light beams 34a are reflected by the HOEs 32a and reflected back as collimated light beams 36a. Those light beams 34a emanating from the middle pixel element 28a-m are labeled 34a-m, and the corresponding collimated light beams are labeled 36a-m. It can be seen that the reflected collimated light beams 36a-m are substantially parallel to each other in the direction of a schematically indicated exit pupil 38a of the display device 10a. Each HOE 32a associated with the display segment 26a produces a collimated light beam 36a from a light beam 34a emitted by a particular pixel element 28a of the display segment 26a, which collimated light beam 36a is substantially parallel to the collimated light beams 36a which are produced by all other HOEs 32a associated with the display segment 26a from the emitted light of the particular pixel element 28a. This applies equally to all other pixel elements 28a of the display segment 26a. Their emitted light is also converted by the associated HOEs 32a, respectively, into collimated light beams 36a that are substantially parallel to each other from HOE 32a to HOE 32a for a given pixel element 28a.

However, the collimated light beams 36a of different pixel elements 28a of the display segment 26a need not necessarily also be parallel to each other. Such collimated light beams 36a may instead travel at an angle to each other. Thus, for purposes of illustration, a light beam 34a-u is depicted in FIG. 3 for the upper pixel element 28a-u of the three pixel elements 28a shown, which is emitted from this upper pixel element 28a-u and impinges on the upper of the three HOEs 32a shown. The upper HOE 32a generates from this light beam 34a-u of the upper pixel element 28a-u a collimated light beam 36a-u which is not parallel but at a comparatively small acute angle to the collimated light beams 36a-m of the middle pixel element 28a-m. Although not shown graphically in FIG. 3, the other HOEs 32a associated with the display segment 26a (i.e., in FIG. 3, the middle HOE 32a and the lower HOE 32a) also each generate a collimated light beam 36a from the light of the upper pixel element 28a-u that extends at substantially the same (small) angle to the collimated light beams 36a-m of the middle pixel element 28a-m.

In addition, in FIG. 3—again purely for the purpose of illustration-a light beam 34a-1 is depicted for the lower pixel element 28a-1 of the three pixel elements 28a shown, which is emitted from this lower pixel element 28a-l and impinges on the upper of the three HOEs 32a shown. The upper HOE 32a generates from this light beam 34a-l of the lower pixel element 28a-1a collimated light beam 36a-l which is not parallel but at a comparatively small acute angle to the collimated light beams 36a-m of the middle pixel element 28a-m, and at an angle to the collimated light beam 36a-u of the upper pixel element 28a-u. Although again not shown graphically in FIG. 3, the remaining HOEs 32a associated with the display segment 26a (i.e. in FIG. 3, the middle HOE 32a and the lower HOE 32a) each generate a collimated light beam 36a from the light of the lower pixel element 28a-l that passes at substantially the same angle to the collimated light beams 36a-m of the middle pixel element 28a-m and at substantially the same angle to the collimated light beams 36a-u of the upper pixel element 28a-u.

In this manner, each of the HOEs 32a associated with the display segment 26a reflects the sub-image portion emitted by the display segment 26a in substantially the same direction. However, because the respective sub-image portion—as viewed over the extension of the active area of the display device 10a—is reflected not only once but several times at different locations of the active area 24a, an overall enlarged exit pupil 38a of the display device 10a can be realized. Because the individual HOEs 32a can have a comparatively small size, they can still have a comparatively large f-number, which is advantageous for lower aberrations. Depending on the number of HOEs 32a associated with a display segment 26a, and depending on the extension of the associated group of HOEs 32a within the active area 24a of the display device 10a, a more or less large exit pupil 38a can be realized.

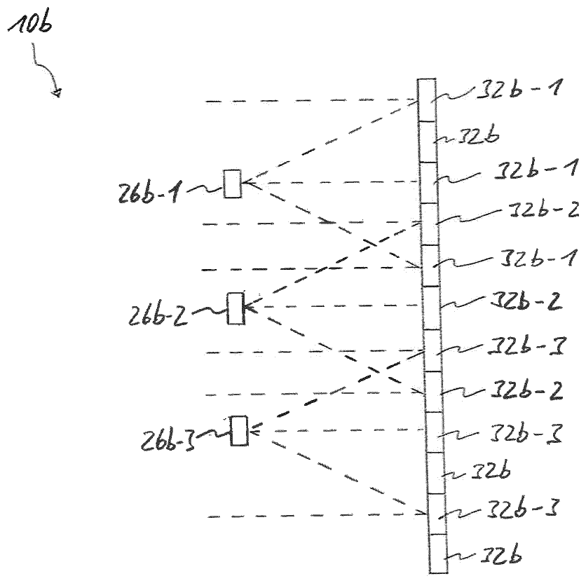

FIG. 4 shows an embodiment which is based on the concept of the embodiment of FIG. 3 having one group of HOEs each assigned to one display segment. In order to better distinguish the assignment of the HOEs to the display segments, both the display segments 26b and the HOEs 32b are identified by an appended number in FIG. 4. Identical appended numbers denote association, while different appended numbers denote lack of association.

In FIG. 4, the HOEs 32b associated with a particular display segment 26b are interleaved along the extension of the active area 24b with the HOEs 32b of one or more other display segments 26b. An HOE 32b of a different display segment 26b is disposed between each two nearest HOEs 32b of the same display segment 26b. For example, either an HOE 32b-1 of the upper display segment 26b-1 or an HOE 32b-3 of the lower display segment 26b-3 is arranged between two next HOEs 32b-2 of the middle display segment 26b-2 in FIG. 4. It is understood that this is only exemplary, and that two or more HOEs 32b of other display segments 26b may instead be disposed between two closest HOEs 32b of one display segment 26b.

The interleaving may be configured such that the HOEs 32b are all arranged in the same plane (i.e., side by side with or without mutual overlap). Alternatively, it is conceivable that the HOEs 32b are distributed on different planes, such that the HOEs 32b of a partial number of the display segments 26b are arranged next to each other in a first plane and the HOEs 32b of another partial number of the display segments 26b are arranged next to each other in another, second plane.

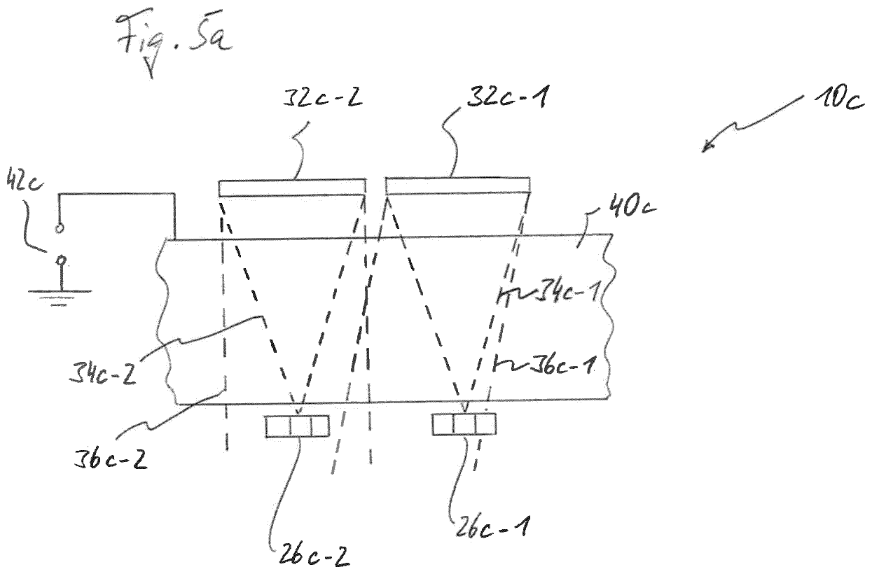

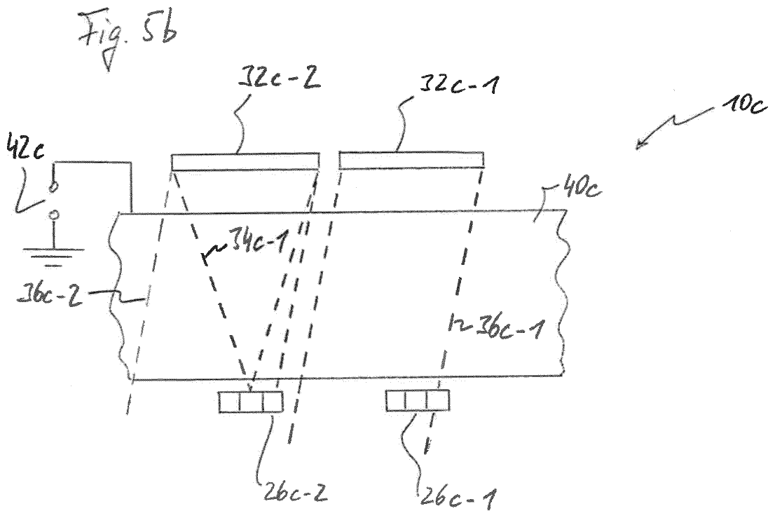

Reference is now made to the embodiment of FIGS. 5a and 5b. In this embodiment, an electrically controllable beam steering material 40c, for example based on liquid crystals, is arranged in the light propagation path between the display segments 26c and the reflective HOEs 32c. In the example case shown, the beam steering material 40c is shown graphically as a single layer, but in practice it can optionally be formed in a single layer or in multiple layers. Spatially, the beam steering material 40c is also arranged between the display segments 26c and the reflective HOEs 32c. By means of a controllable voltage source 42c, two electrical potentials that differ with respect to their polarity or/and strength can be applied to the beam steering material 40c, e.g., a positive and a negative electrical potential. One of the two electrical potentials may be a neutral potential (ground potential), at least in certain embodiments. Depending on the applied electrical potential, the beam steering material 40c has a different light steering effect on light emitted from the display segments 26c and passing through the beam steering material 40c (along the path from the pixel elements 28c to the HOEs 32c and thence toward the exit pupil of the display device 10c). Accordingly, each of the applied electrical potentials corresponds to a different steering state of the beam steering material 40c. A control circuit not shown in detail in FIGS. 5a, 5b, which is for example the control circuit 30 of FIG. 2, is used to control the voltage source 42c.

FIG. 5a concerns a situation at a time t0, FIG. 5b a situation at a later time t1, which is not later than at most a few hundred milliseconds than the time t0. To make it easier to distinguish the assignment of the HOEs 32c to the display segments 26c, the display segments 26c and the HOEs 32c are again each identified by an appended number in FIGS. 5a, 5b.

At the time t0 according to FIG. 5a, the display segment 26c-1 emits a first sub-image portion, and the adjacent display segment 26c-2 emits a second sub-image portion. In certain embodiments, the two sub-image portions represent different image contents of an artificial image produced by the display device 10c. The sub-image portion emitted by the display segment 26c-1 is represented in FIG. 5a by a light beam 34c-1 emitted by one of the pixel elements 28c of the display segment 26c-1, and a collimated light beam 36c-1 resulting after reflection at the associated HOE 32c-1; the sub-image portion emitted by the display segment 26c-2 is similarly represented by a light beam 34c-2 and a resulting collimated light beam 36c-2. The respective pixel element 28c of the display segment 26c-2 is arranged at the same position within the display segment 26c-2 as the respective pixel element 28c of the display segment 26c-1; in the example case shown, light beams emitted from the respective middle pixel element 28c of the display segments 26c-1, 26c-2 are considered.

It can be seen that in the first steering state of the beam steering material 40c according to FIG. 5a, the propagation direction of the collimated light beams 36c-1, 36c-2 is not identical; instead, the collimated light beams 36c-1, 36c-2 propagate in slightly different directions. This is representative of a correspondingly different direction in which the sub-image portions emitted by the display segments 26c-1, 26c-2 leave the display device 10c at the exit pupil.

In the second steering state of the beam steering material 40c according to FIG. 5b, on the other hand, the steering effect of the beam steering material 40c is such that the propagation direction of the collimated light beam 36c-2 of the display segment 26c-2 is substantially parallel to the propagation direction of the collimated light beam 36c-1 of the display segment 26c-1 in the first steering state according to FIG. 5a. This is shown schematically in FIG. 5b, with the collimated light beam 36c-1 of FIG. 5a (i.e. at time t0) drawn in supplementary and for comparison. This steering effect of the beam steering material 40c can be used to emit at time t1 a sub-image portion from the display segment 26c-2 which is identical in content to the sub-image portion which was emitted at time to from the display segment 26c-1. The sub-image portion of the display segment 26c-2 emitted at the time t1 then exits the display device 10c in substantially the same direction, but spatially offset, as the sub-image portion emitted by the display segment 26c-1 at the time t0. A virtual pixel position at the location of the display segment 26c-1 can be constructed for the collimated light beam 36c-2 at the time t1; the user has the impression that the sub-image portion emitted by the display segment 26c-2 at the time t1 has been generated at the location of the display segment 26c-1.

In certain embodiments, the steering state of the beam steering material 40c is controllable only globally, i.e. uniformly for all display segments 26c. In other embodiments, it is conceivable that the steering state of the beam steering material 40c is adjustable on a segment-by-segment basis, i.e. individually for each display segment 26c.

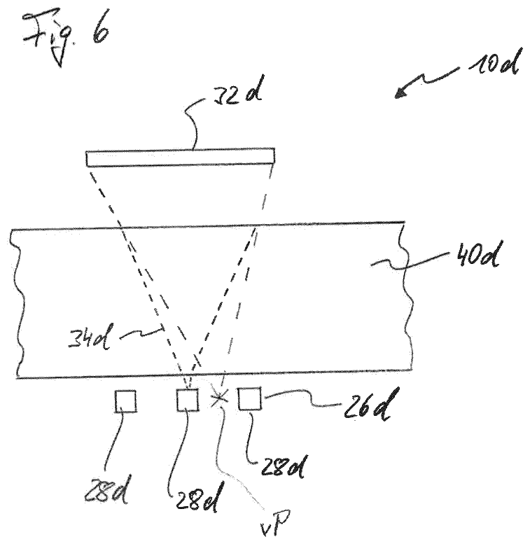

FIG. 6 illustrates an embodiment in which the beam steering material 40d is used to increase the resolution of the artificial image produced by the display device 10d relative to the actual physical resolution (given by the number of pixel elements 28d per display segment 26d). The pixel elements 28d of the illustrated display segment 26d are shown graphically in FIG. 6 with a certain mutual spacing, which is intended to illustrate the physical spacing between adjacent pixel elements 28d of a display segment 26d, which is regularly unavoidable in practice. By suitable design and control of the beam steering material 40d, it can be achieved that the virtual pixel position of a pixel element 28d in a second steering state of the beam steering material 40d is shifted by approximately half the intrasegment pixel spacing or another fraction of the intrasegment pixel spacing with respect to the virtual pixel position of the pixel element 28d in a first steering state of the beam steering material 40d. In this manner, in the second steering state, a sub-image portion may be displayed by the display segment 26d with a pixel raster that is shifted from the pixel raster of a sub-image portion displayed by the display segment 26d in the first steering state by a corresponding fraction of the intrasegment pixel pitch. If the display of the two sub-image portions is sufficiently rapid in sequence, the user has the impression of a resulting sub-image portion of increased resolution.

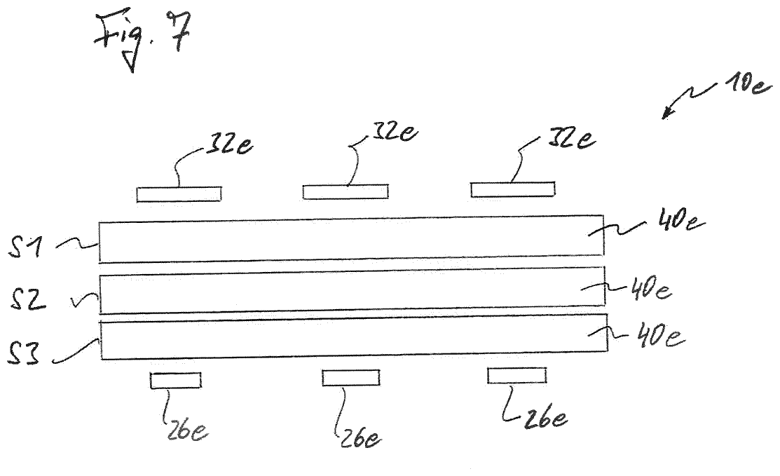

In the embodiment example according to FIG. 7, a beam steering material 40c is also arranged in the space between the display segments 26e and the HOEs 32e. Here, however, the beam steering material 40c is distributed over several (here: three) layers S1, S2, S3, which can be controlled individually, i.e. independently of one another, with regard to their steering state by a control circuit not shown in more detail in FIG. 7 (for example the control circuit 30 of FIG. 2). The layers S1, S2, S3 can consist of the same material or at least partly of different materials. By distributing the beam steering material 40e over several individually controllable beam steering layers, more complex deflection patterns of the light beams emitted by the pixel elements 28e of the display segments 26e can be realized. Depending on the combination of steering states of the different beam steering layers, several different virtual pixel positions of the pixel elements 28c of a display segment 26e can be realized. This increases the range of possible applications. Within each beam steering layer S1, S2, S3, moreover, segment-individual controllability of the beam steering material 40e is again conceivable, i.e. individually for each display segment 26c.

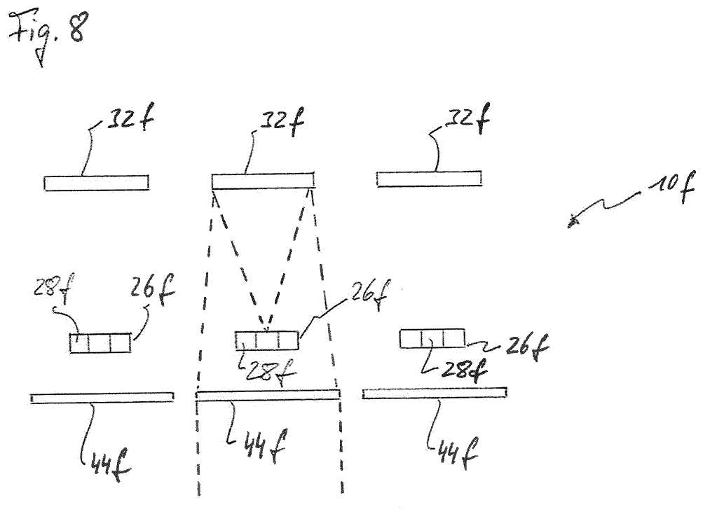

In the embodiment according to FIG. 8, each display segment 26f is assigned a plurality of holographic optical elements, again. However, in contrast to the embodiments according to FIGS. 3 and 4, where a plurality of reflective HOEs arranged side by side in the light propagation path are associated with each display segment, these comprise a reflective HOE 32f and a transmissive HOE 44f, which are arranged one behind the other in the beam path of the light emitted by the respective display segment 26f. The respective display segment 26f is spatially arranged between the HOEs 32f, 44f, as can be easily seen in FIG. 8. Both HOEs 32f, 44f together cause collimation of the light beam 34f emitted from a pixel element 28f of the relevant display segment 26f. Because the HOE 44f also has a divergence-reducing effect, the divergence-reducing power required to collimate the light beam 34f need not be provided by the HOE 32f alone. Part of this divergence reduction power can be provided by the HOE 44f. With a given size of the exit pupil of the display device 10f, an overall high imaging quality of the collimating optical system with lower aberrations can nevertheless be achieved in this way.

In a variation of the embodiment of FIG. 8, the HOEs 44f may be replaced by lens elements or transmissive diffractive elements. The HOEs 44f (or their replacement elements) may be attached directly to the relevant see-through element of the display device 10f, to which the display segments 26f and the HOEs 32f are also attached.

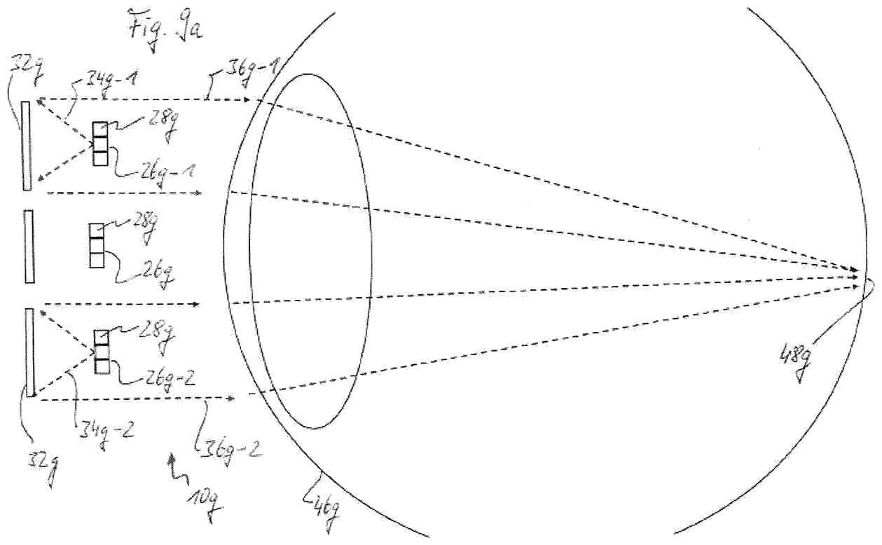

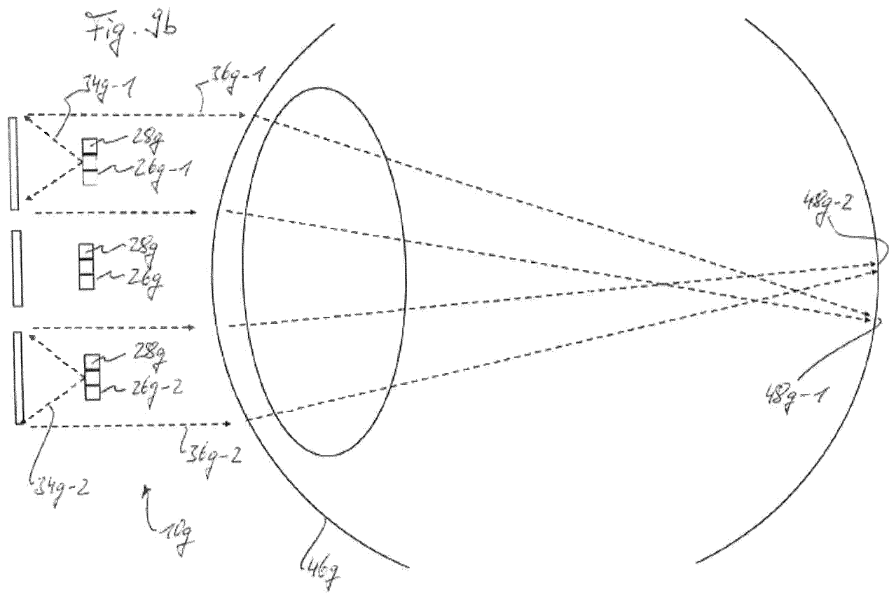

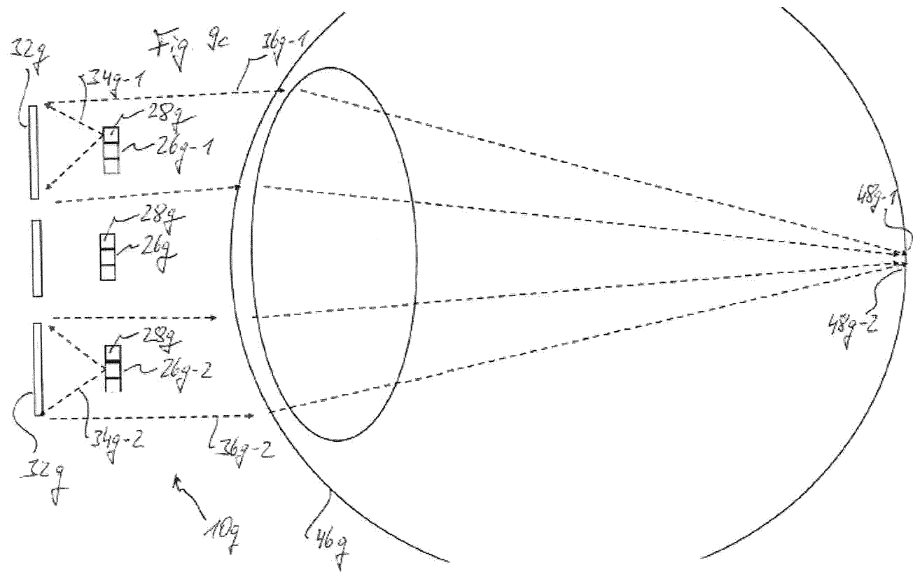

Finally, reference is made to the embodiment according to FIGS. 9a, 9b, 9c. There, the case is considered in which the sub-image portion emitted by one of the display segments 26g of the display device 10g is correctly focused on the macula and, in particular, the fovea when the user's eye is focused at far distance. However, when the eye is focused at near distance, misfocusing of the sub-image portion emitted by the respective display segment 26g may occur, and such misfocusing may manifest itself, in particular, in the eye focusing the respective sub-image portion to a different retinal location than sub-image portions emitted by other display segments 26g. Such misfocusing may be particularly troublesome if a sub-image portion is emitted simultaneously in multiple replication from different display segments and the different copies are all focused on essentially the same retinal location when the eye is focused at far, but the focal locations diverge when the eye is focused at near.

In this respect, FIG. 9a shows the situation that two display segments 26g-1, 26g-2, which are separated by at least one other display segment 26g, each emit the same sub-image portion. As a representation of the emitted subimage portions, FIG. 9a shows for each of the two display segments 26g-1, 26g-2 a light beam 34g-1, 34g-2 emitted from a middle one of the pixel elements 28g, which is formed into a corresponding collimated light beam 36g-1, 36g-2 by an HOE 32g-1, 32g-2 associated with the respective display segment. The two collimated light beams 36g-1, 36g-2 enter an eye 46g of the user and are focused on the retina. It can be seen that when the eye 46g is focused at far distance, the collimated light beams 36g-1, 36g-2 are focused on the same retinal location, denoted 48g in FIG. 9.

In contrast, FIG. 9b illustrates the case of near focusing of eye 46g. In this situation, the retinal focal locations of the two collimated light beams 36g-1, 36g-2 are no longer congruent; instead, each of the collimated light beams 36g-1, 36g-2 is focused on its own retinal focal location 48g-1 and 48g-2, respectively. The image perceived by the user no longer appears sharp.

To eliminate this misfocusing, the display position of the sub-image portion can be shifted by at least one pixel position in at least one of the display segments 26g-1, 26g-2 in question. This is shown in FIG. 9c. There, the display position (emission position) of the sub-image portion emitted by the display segment 26g-1 is shifted by one pixel position. This is illustrated in FIG. 9c by the fact that the light beam 34g-1, which carries the same pixel content as the light beam 34g-2, is no longer emitted by the middle pixel element 28g of the display segment 26g-1, but by the upper of the three pixel elements 28g shown. Accordingly, the display position of the sub-image portion emitted from the display segment 26g-1 is shifted by one pixel position. It can be said that the segment-internal position (intrasegment position) of the displayed sub-image portion has been shifted by one pixel position. Due to the shift of the intrasegment position of the sub-image portion at the display segment 26g-1, the retinal focus location 48g-1 also shifts. In the example case shown, this shift is sufficient to bring the retinal focus location 48g-1 back as much as possible into congruence with the retinal focus location 48g-2. Despite a change in the focusing state of the eye 46g (near focus instead of far focus), the image perceived by the user appears sharp again.

The expected focusing state of the eye 46g can be derived by a control circuit of the display device 10g, which is not shown in detail in FIGS. 9a, 9b, 9c (for example the control circuit 30 of FIG. 2), from the image data representing the image contents to be displayed by the display device 10g. If long-distance focusing or focusing to infinity is expected, the control circuit controls the display segment 26g-1 such that the sub-image portion to be displayed is displayed at a first intrasegment position of the display segment 26g-1 (for example, corresponding to FIG. 9a). If, on the other hand, a close focus of the eye 46g is to be expected, the control circuit controls the display segment 26g-1 in such a way that the sub-image portion to be displayed is displayed at a second intrasegment position which is shifted by at least one pixel position with respect to the first intrasegment position (for example, according to FIG. 9c).

It is understood that the explained principle of shifting the intrasegment display position of a sub-image portion may pertain to several different display segments 26g of the display device 10g depending on the expected focusing state of the eye 46g, and that the required amount of shifting may be different for different display segments 26g.

1. A head-wearable display device, comprising:
a see-through member providing a transparent see-through area;
a plurality of more than two display segments to emit sub-image portions of a display image, the plurality of display segments disposed on the see-through member in a manner distributed across a display area of the see-through member, each of the plurality of display segments comprising a plurality of pixel elements, wherein an intra-segment pixel distance is smaller than an inter-segment pixel distance;
a collimating optical system disposed on the see-through member to direct the sub-image portions towards an exit pupil of the display device, wherein the collimating optical system includes, in relation to each of the plurality of display segments, at least one collimating optical element configured to direct the sub-image portion emitted by the associated display segment towards the exit pupil;
a controllable beam steering material disposed on the see-through element between the display segments and the collimating optical elements in at least one beam steering layer in the propagation path of the sub-image portions; and
control circuitry to control the beam steering material between different steering states.

2. The head-wearable display device of claim 1, wherein the control circuitry is configured to control a first display segment to emit a sub-image portion at a first point in time, control a second display segment to emit the same sub-image portion at a second point in time and control the beam steering material to assume a different steering state at the second point in time than at the first point in time such that the sub-image portion emitted by the second display segment at the second point in time leaves the display device substantially in the same direction as the sub-image portion emitted by the first display segment at the first point in time.

3. The head-wearable display device of claim 1, wherein the control circuitry is configured to control a display segment to emit a first sub-image portion at a first point in time, control the display segment to emit a second sub-image portion at a second point in time, and control the beam steering material to assume a different steering state at the second time point than at the first time point, such that the two sub-image portions emitted by the display segment at the first and second time points leave the display device with interlaced pixel rasters.

4. A head-wearable display device, comprising:
a see-through member providing a transparent see-through area;
a plurality of more than two display segments to emit sub-image portions of a display image, the plurality of display segments disposed on the see-through member in a manner distributed across a display area of the see-through member, each of the plurality of display segments comprising a plurality of pixel elements, wherein an intra-segment pixel distance is smaller than an inter-segment pixel distance;
a collimating optical system disposed on the see-through member to direct the sub-image portions towards an exit pupil of the display device, wherein the collimating optical system includes, in relation to each of the plurality of display segments, at least one collimating optical element configured to direct the sub-image portion emitted by the associated display segment towards the exit pupil; and
control circuitry to control the display segments, wherein the control circuitry is configured to control at least one of the display segments to emit a sub-image portion at a selected one of a first intra-segment position and a second intra-segment position based on an expected eye focusing state, the second intra-segment position being shifted relative to the first intra-segment position by at least one pixel element.

5. A head-wearable display device, comprising:
a see-through member providing a transparent see-through area;
a plurality of more than two display segments to emit sub-image portions of a display image, the plurality of display segments disposed on the see-through member in a manner distributed across a display area of the see-through member, each of the plurality of display segments comprising a plurality of pixel elements, wherein an intra-segment pixel distance is smaller than an inter-segment pixel distance between neighboring display segments; and
a collimating optical system disposed on the see-through member to direct the sub-image portions towards an exit pupil of the display device, wherein the collimating optical system includes, in relation to each of the plurality of display segments, a first optical element and a second optical element disposed successively in the propagation path of the sub-image portion emitted by the associated display segment, each of the first and second optical elements designed to reduce the divergence of a beam carrying the sub-image portion, one of the first and second optical elements effective to reflect the beam and the other of the first and second optical elements effective to transmit the beam.

6. A head-wearable display device, comprising:
a see-through member providing a transparent see-through area;
a plurality of more than two display segments to emit sub-image portions of a display image, the plurality of display segments disposed on the see-through member in a manner distributed across a display area of the see-through member, each of the plurality of display segments comprising a plurality of pixel elements, wherein an intra-segment pixel distance is smaller than an inter-segment pixel distance; and
a collimating optical system disposed on the see-through member to direct the sub-image portions towards an exit pupil of the display device, wherein the collimating optical system includes, in relation to each of the plurality of display segments, a respective plurality of collimating optical elements each configured to direct the sub-image portion emitted by the associated display segment towards the exit pupil with substantially the same direction.

7. The head-wearable display device of claim 6, wherein collimating optical elements disposed in a neighboring relationship along the display area are associated with different display segments.

8. The head-wearable display device of claim 1, wherein the collimating optical system comprises holographic optical elements.

9. The head-wearable display device of claim 2, wherein the control circuitry is configured to control a display segment to emit a first sub-image portion at a first point in time, control the display segment to emit a second sub-image portion at a second point in time, and control the beam steering material to assume a different steering state at the second time point than at the first time point, such that the two sub-image portions emitted by the display segment at the first and second time points leave the display device with interlaced pixel rasters.

10. The head-wearable display device of claim 4, wherein the collimating optical system comprises holographic optical elements.

11. The head-wearable display device of claim 5, wherein the collimating optical system comprises holographic optical elements.

12. The head-wearable display device of claim 6, wherein the collimating optical system comprises holographic optical elements.
